(19) United States
(12) Patent Application Publication
(10) Pub. No.: US 2015/0077925 A1
(43) Pub. Date: Mar. 19, 2015

(54) SET TOP BOX HAVING REMOVABLE HARD DRIVE

(71) Applicant: THOMSON LICENSING, Issy de Moulineaux (FR)

(72) Inventors: Mickey Jay Hunt, Camby, IN (US); William Phillip Dernier, Indianapolis, IN (US)

(21) Appl. No.: 14/390,939

(22) PCT Filed: Apr. 10, 2013
(86) PCT No.: PCT/US2013/035880

§ 371 Date: Oct. 6, 2014

Related U.S. Application Data
(60) Provisional application No. 61/623,909, filed on Apr. 13, 2012.

(51) Int. Cl. G06F 1/18

(52) U.S. Cl. CPC G06F 1/187
USPC 361/679.39

(57) ABSTRACT

An electronic device such as a set top box is provided that includes a frame having flat bottom; a flat circuit board generally parallel to the flat bottom in which the flat circuit board has at least one aperture; at least one boss that extends from the flat bottom and extends through the at least one aperture in which the at least one boss has a screw receiving aperture; and an electronic component such as a hard drive or smart card assembly over the circuit board and electrically connected to the circuit board in which the electronic component has at least one screw to fasten the electronic device to the boss. The electronic component is supported by the bosses and not supported by the flat circuit board.

### CROSS-REFERENCE TO RELATED APPLICATIONS

This application claims priority from U.S. Provisional Application 61/623,909 filed on Apr. 13, 2012 which is incorporated by reference herein in its entirety.

### FIELD OF THE INVENTION

The invention relates to mounting and supporting hard drives in electronic devices.

### BACKGROUND

In set top boxes and the like, electronic components can apply detrimental mechanical loads to circuit boards. Component such as hard drives can particularly jeopardize circuit boards when they are mounted on or near circuit boards.

Because set top boxes and the like are increasingly using hard drives, a need exists to mount hard drives on or near circuit boards in a manner that lowers risks to boards.

The invention provides a novel support for a hard drive over a circuit board that eliminates the mechanical load on the circuit board and prevents risk of damage to the board.

### SUMMARY OF THE INVENTION

Embodiments of the invention include devices such as set top boxes that include a frame or chassis having a bottom; a circuit board over the bottom in which the circuit board has at least one aperture; and at least one boss extending from the bottom and having a mounting aperture in which the boss extends toward the at least one aperture; an electronic component assembly over the circuit board and electrically connected to the circuit board in which the electronic component assembly has at least one bolt engaged in a corresponding bolt shaft, the bolt shaft extends through the at least one aperture of the circuit board, the bolt shaft surrounds and contacts the boss and the bolt fastens the electronic device assembly to the boss. The electronic component assembly is supported by the bosses and not supported by the flat circuit board.

The electronic component assembly can include an electronic component such as a hard drive; a drawer that houses the electronic component; and receiving bay into which the drawer slides. Corresponding bolt shafts can extend from a bottom surface of the receiving bay. The receiving bay can comprise a pair of slots to enable the drawer to slide into the receiving bay and the drawer can have a pair of rails that engage the slots of the receiving for further enabling of the drawer to slide into receiving bay. The drawer can additionally have at least one protruding rib on a front wall and at least one protruding rib on a rear wall that contact a top surface of the electronic component to secure the electronic component in the drawer. The receiving bay can further include two bolt shafts positioned closer to the rear wall of the receiving bay than a front portion of the receiving bay. The bosses can be vertically oriented and cylindrically shaped such that the bosses have an upper surface that contact a portion of the bolt shaft to support the receiving bay. Additionally, the bolt shafts can be vertically oriented and have an upper cylindrical portion and a lower cylindrical portion in which the lower cylindrical portion has an inner diameter that is large enough to permit the bosses to be positioned within the lower cylindrical portion. The upper cylindrical portion can have an inner diameter smaller than the inner diameter of the lower cylindrical portion and the inner diameter of the upper cylindrical portion can be smaller than the outer diameter of the portion of the boss, whereby the portion of the bolt shaft that contacts the upper surface of the boss is the upper cylindrical portion. The device can further include a bolt having a head that contacts an upper surface of the upper the cylindrical portion to secure the receiving bay. The lower cylindrical portion can also have an outer diameter that is smaller than the outer diameter of the upper cylindrical portion, wherein an inner surface of the lower cylindrical portion of the blot shaft surrounds and contacts the boss. The boss can be supported on a base portion having a diameter larger than the outer diameter of the lower cylindrical portion of the bolt shaft such that the circuit board has a top surface that contact the lower cylindrical portion around the aperture of the circuit board and the circuit board has a bottom surface that contacts a ledge of the base portion around the aperture of the circuit board. The circuit board can also include an electrical connecter mounted on the top surface of the circuit board such that the electrical connector protrudes through an opening in a bottom wall of the receiving bay, whereby the hard drive is electrically connected to the electrical connecter when the drawer is in a closed position.

### BRIEF DESCRIPTION OF THE DRAWINGS

The invention will be explained in detail with reference to the drawings in which:

FIG. 1 shows a perspective view of a set top box incorporating a removable hard drive according to the invention;

FIG. 2 shows another perspective view of the set top box incorporating the removable hard drive according to the invention;

FIG. 3 shows views of the removable hard drive mounted in the hard drive drawer according to the invention;

FIG. 4 shows a view of the electronic device according to the invention in a disassembled state;

FIG. 5 shows bottom perspective views of a set top box incorporating the removable hard drive according to the invention;

FIG. 6 shows views of the mounting and support system for the hard drive receiving bay according to the invention; and

FIG. 7 shows another view of the removable hard drive mounted in the hard drive drawer according to the invention.

### DETAILED DESCRIPTION OF THE EMBODIMENTS

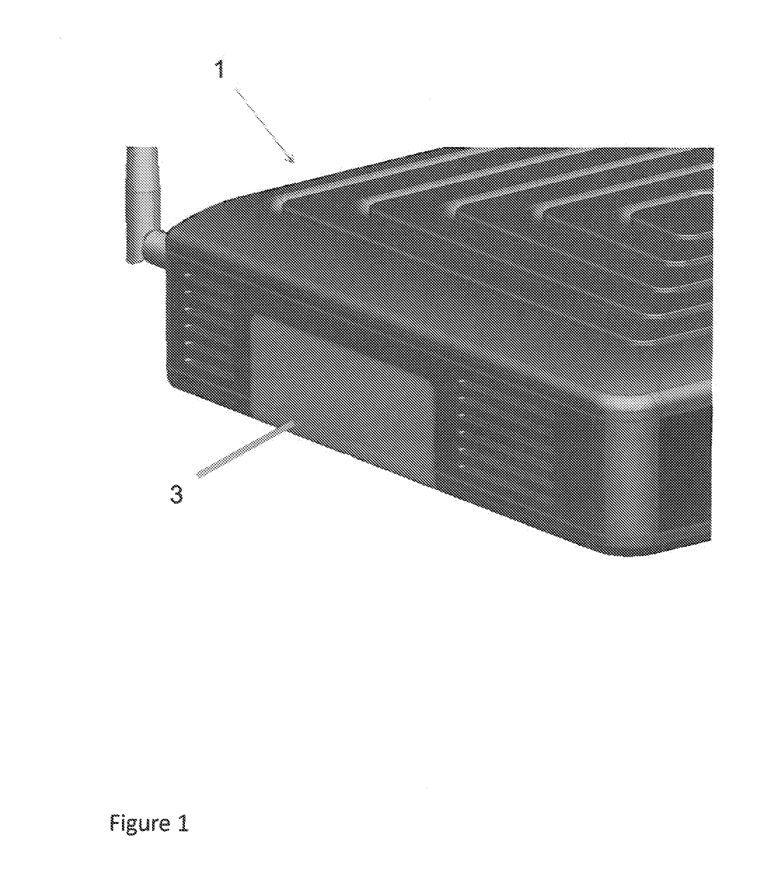

FIG. 1 shows a set top box 1 according to the invention that includes a removable hard drive 12 in a hard drive drawer 3. Shown in FIG. 1 is the exterior portion of the sliding drawer 3 which houses the removable hard drive 12 or functional equivalent.

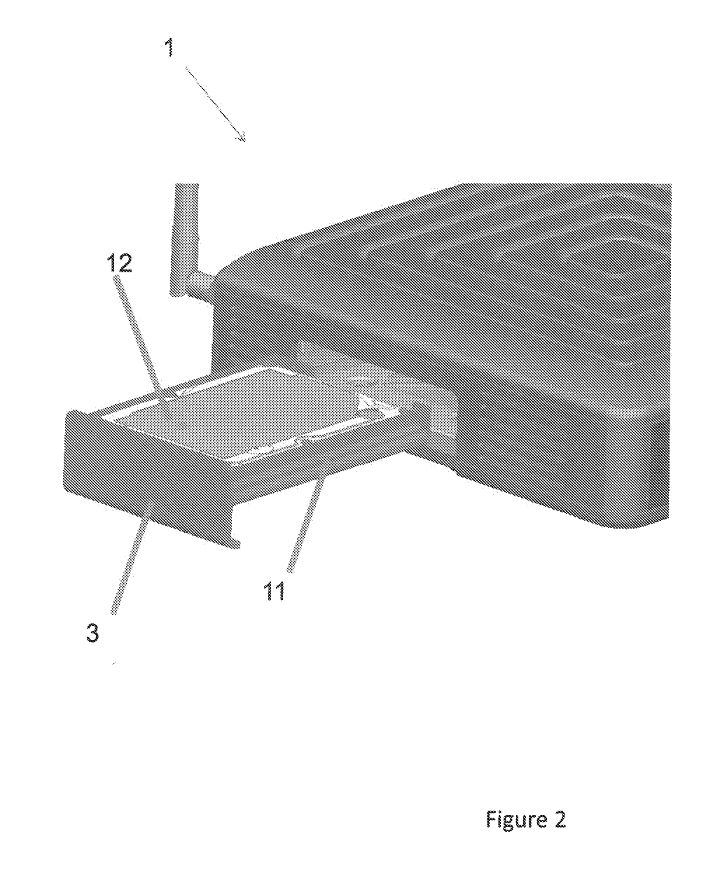

FIG. 2 shows another view of the set top box according to the invention in which the hard drive drawer 3 is in the open position. Rails or grooves 11 extend along the long axis of the hard drive drawer 3 and can be on both long vertical sides of the drawer. The rails or grooves 11 can be horizontally oriented and permit the hard drive drawer to be slidable.

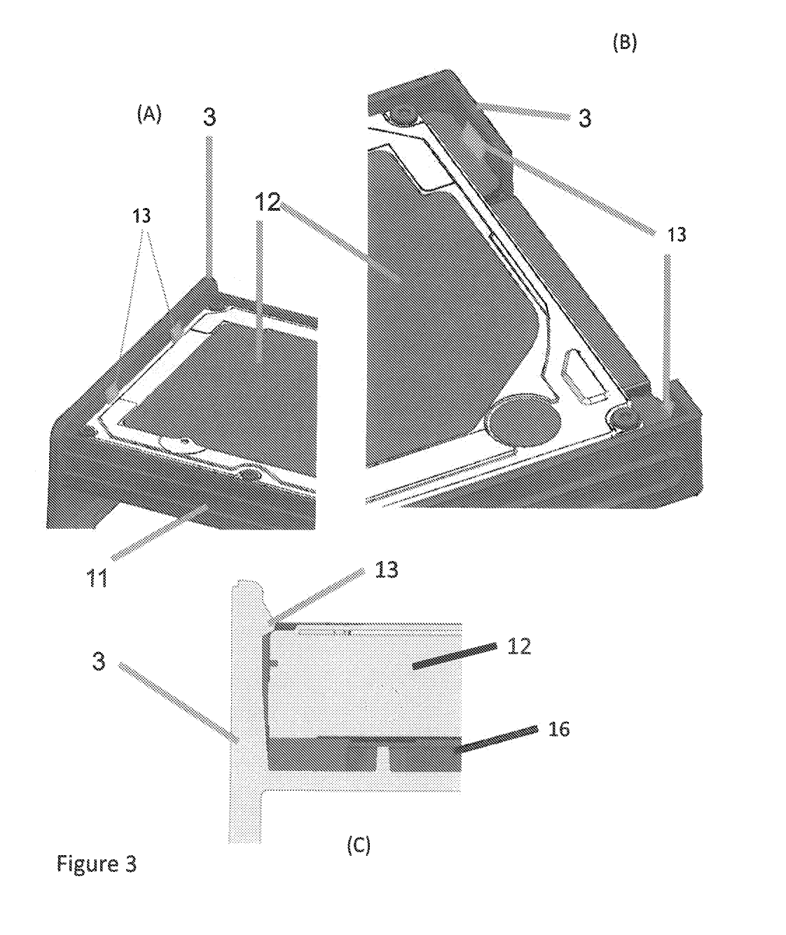

FIG. 3 shows various views of the removable hard drive 12 mounted in the hard drive drawer 3. The hard drive 12 can be held down by ribs or under-cut ribs 13 on the interior side of the front wall as shown in FIG. 3(A) and ribs 13 on the back wall of the drawer 3 as shown in FIG. 3(B). These views show a presently preferred means for securing the hard drive 12 within the drawer 3 by the plurality of protruding ribs 13 on two interior walls of the drawer. The ribs 13 can have a triangular shape as shown in FIG. 3(C) that can permit the hard drive 12 to slide into and out of the drawer 3 as needed. The ribs 13 provide enough of a protrusion to inhibit the hard drive from freely dislodging; however, the ribs can be angled and dimensioned such that with appropriate upward force for removal or appropriate downward force for entry the wall(s) of the drawer can slightly flex outward to permit the hard drive to slide into or out of the drawer 3, respectively. FIG. 3C also shows how a base 16 of the drawer helps support the hard drive in combination with the ribs 13.

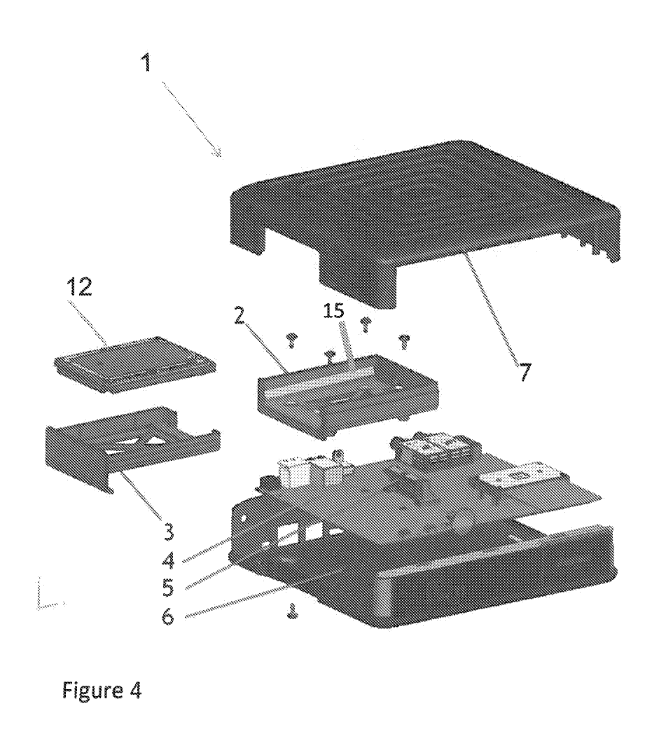

FIG. 4 shows a disassembled view of the set top box or electronic device 1 that has an electronic component 12 (such as a hard drive or smart card assembly) placed in a drawer or other carrier 3. A hard drive receiving bay 2, which can be referred to as a guide or receiver, and a connector 5 can be securely mounted to and/or over a printed circuit board 4 as well as the frame or chassis 6. The hard drive receiving bay 2 and the drawer 3 each can have an aperture that are aligned with the connector 5 to permit the electronic component 12 to be electrically connected to the connector to operate. The apertures can be located near the interior end of the hard drive receiving bay 2 and the drawer 3. A cover 7 is secured to the frame/hard drive receiving bay/circuit board assembly. The component/drawer assembly can be inserted or removed from the assembly without cover removal. This allows for the exchange, addition and/or upgrade to the component to be performed quickly and easily. The bay 2 is shown with interior slots 15 to receive the side rails 11 of the drawer 3. However, the bay could alternatively have exterior rails to engage the drawer.

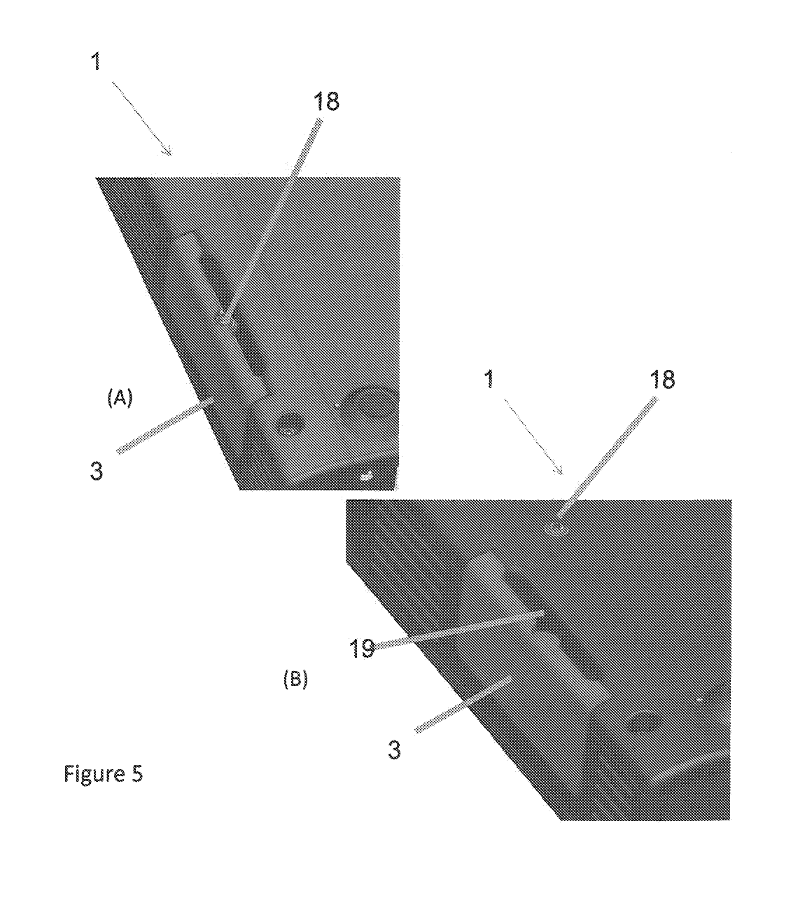

FIG. 5 shows bottom perspective views of the set top box in the vicinity of the sliding drawer. The sliding drawer 3 has a finger slot 19 for a user to open the drawer that is hidden from view when the set top box is correctly positioned on a mounting surface. The sliding drawer 3 has the feature of a locking screw or bolt 18 that can be applied to the bottom of the drawer near the exterior end of the drawer that prevents the drawer from opening during shipping as shown in FIG. 5(A). In operation, the screw can be removed to allow for easy access to the hard drive as shown is FIG. 5(B). A purpose of this screw is to make sure the hard drive drawer 3 does not open during shipping.

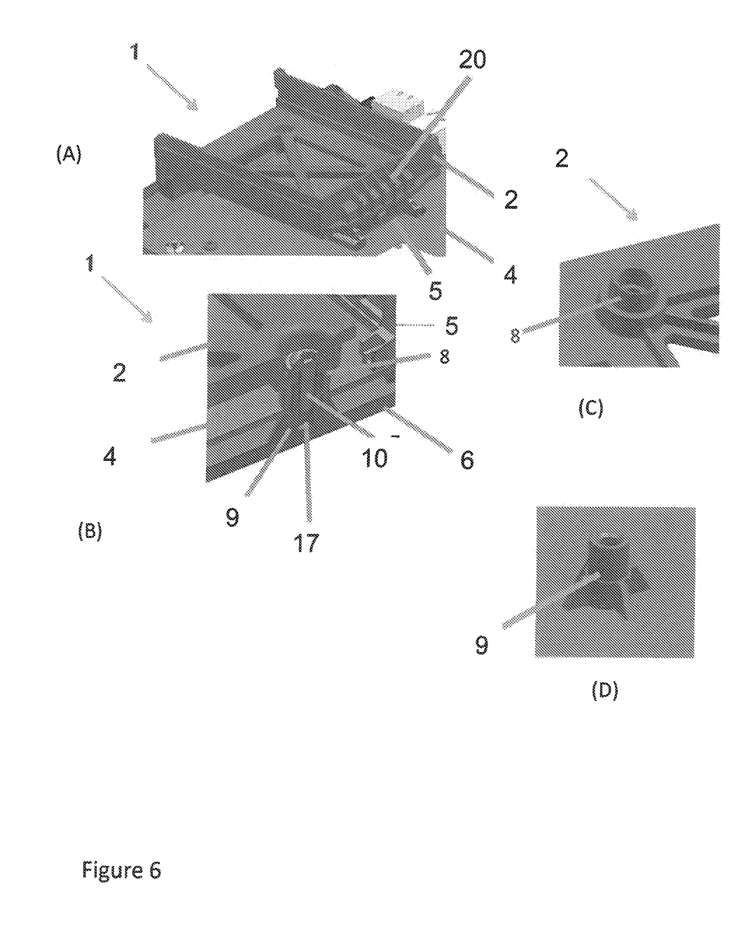

FIG. 6 show views for supporting an electronic component such as a hard drive or smart card assembly in an electronic device such as a set top box. In this embodiment, the set top box 1 as shown is FIG. 6(B) can have a frame or chassis 6 having a flat bottom and a flat circuit board 4 generally parallel to the flat bottom in which the flat circuit board has at least one aperture. FIG. 6(B) shows a view of a support shaft 8 of the bay 2 shown in FIG. 6(A) near the rear wall of the bay adjacent the connector 5. FIG. 6(C) shows a bottom view of the shaft 8 and FIG. 6(D) shows a view of the boss 9 of the chassis 6 that engages and supports the boss 8, thereby supporting the bay 2 and ultimately the hard drive 12. The chassis 6 can have at least one boss 9 that extends from the flat bottom and extends through the at least one aperture of the board 4 and the at least one boss has a receiving aperture 17 for a screw or bolt. This construction permits the electronic component 3 (i.e. hard drive or smart card assembly) to be supported over the circuit board and electrically connected to the circuit board. A screw or bolt 10 secures the bay to the boss 9 when the screw or bolt 10 is inserted into to the corresponding screw shaft 8 and threaded or screwed into the boss 9. The screw shaft 8 surrounds and contacts the boss and the screw fastens the bay 2 to the boss 9 such that the electronic component or hard drive 12 is supported by the bosses instead of being supported by the flat circuit board. This feature is particularly advantageous in that it prevents potential mechanical loads due to the hard drive assembly from applying forces on a circuit board that can damage the circuit board. In other words, this feature lowers the risk to the board by reducing or eliminating the mechanical load. FIG. 6(A) further shows that a hard drive connector can be mounted on main circuit board 4 and positioned on the interior side of the back wall of the receiving bay 2. A rib structure 20 on the exterior side of the back wall of the receiving bay 2 can be provided as shown in FIG. 6(A) to prevent the hard drive connector 5 from flexing and possibly breaking off of the board 4 when the consumer plugs in the hard drive assembly by sliding the drawer 3 into the bay 2. With the construction shown in FIG. 6(B), any Z-force or vertical downward force applied to or by the bay 2 will be applied to the top of the boss of the chassis 6 and not necessarily to the circuit board 4 and any X-Y force or lateral force applied to or by the bay 2 is applied to boss 9 of the chassis 6 and not to the printed circuit board (PCB).

Some nondestructive force can be applied to the board by having the board being pinched or cushioned between the boss and the bolt shaft as shown in FIG. 6(B). Here, the circuit board is stabilized/secured to not move such that the board does not provide the support for the hard drive assembly.

In sum, the boss 9 design essentially applies all stresses to bottom chassis 6 and not to the board 4. In one embodiment, there are at least two of the bosses 9 at the rear of the bay 2.

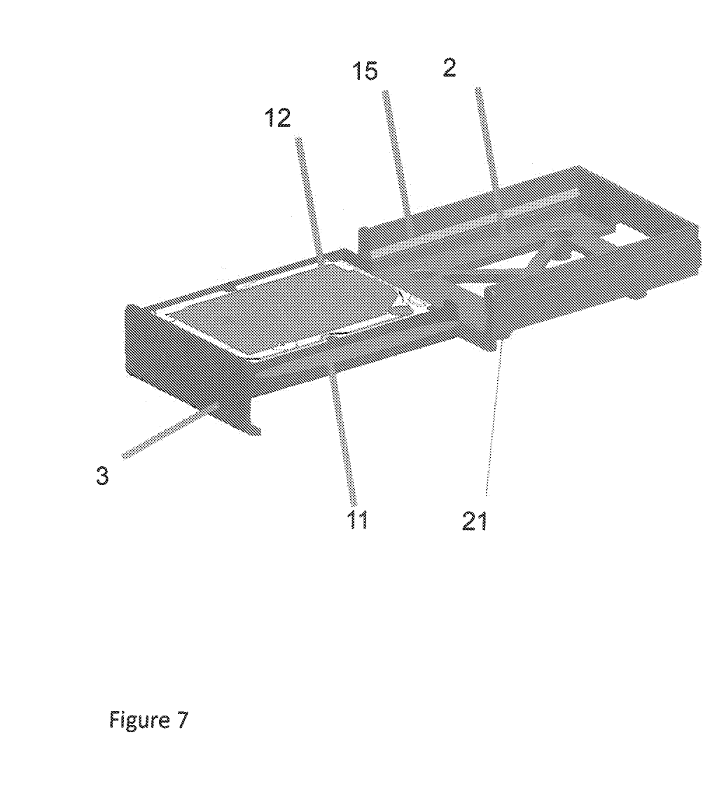

FIG. 7 shows a view of how the hard drive receiving bay 2 receives the drawer 3 and further shows that the bay can include front support rods 21 near the front of the bay. The front support rods 21 can contact the chassis 6 to assist in supporting the front portion of the bay. In some embodiments, the front support rods 21 are positioned outside the periphery of the circuit board 6.

1. A device comprising:
a frame having a bottom;
a circuit board over the bottom, the circuit board having at least one aperture;
at least one boss extending from the bottom and having a mounting aperture, the boss extending toward the aperture;
an electronic component assembly over the circuit board and electrically connected to the circuit board, the electronic component assembly having at least one bolt engaged in at least one corresponding bolt shaft, the bolt shaft extending through the aperture of the circuit board, the bolt shaft surrounding and contacting the boss and the bolt fastening the electronic device assembly to the boss;
wherein the electronic component assembly is supported directly by the at least one boss.

2. The device of claim 1 wherein the electronic component assembly comprises:
an electronic component;
a drawer that houses the electronic component; and
a receiving bay into which the drawer slides;
wherein the bolt shaft extends from a bottom surface of the receiving bay.

3. The device of claim 2 wherein the receiving bay comprises has a pair of slots to enable the drawer to slide into the receiving bay.

4. The device of claim 3 wherein the drawer has a pair of rails that engage the slots of the receiving bay for the drawer to slide into receiving bay.

5. The device of claim 4 wherein the drawer has at least one protruding rib on a front wall and at least one protruding rib on a rear wall that contacts a top surface of the electronic component to secure the electronic component in the drawer.

6. The device of claim 2 wherein the receiving bay has two of the bolt shafts and the bolt shafts each extend through the apertures of the circuit board and engage the bosses.

7. The device of claim 6 wherein the electronic component is a hard drive.

8. The device of claim 7 wherein the bosses are vertically oriented and cylindrically shaped, the bosses having an upper surface that contact a portion of the bolt shaft to support the receiving bay.

9. The device of claim 8 wherein the bolt shafts are vertically oriented and have an upper cylindrical portion and a lower cylindrical portion, wherein
the lower cylindrical portion has an inner diameter that is large enough to permit the boss to be positioned within the lower cylindrical portion, and
the upper cylindrical portion has an inner diameter smaller than the inner diameter of the lower cylindrical portion.

10. The device of claim 9 wherein the inner diameter of the upper cylindrical portion is smaller than the outer diameter of the boss, whereby the portion of the bolt shaft that contacts the upper surface of the boss is the upper cylindrical portion.

11. The device of claim 10 wherein the bolt has a head that contacts an upper surface of the upper the cylindrical portion to secure the receiving bay.

12. The device of claim 11 wherein the lower cylindrical portion has an outer diameter that is smaller than the outer diameter of the upper cylindrical portion, wherein an inner surface of the lower cylindrical portion of the bolt shaft surrounds and contacts the boss.

13. The device of claim 12 wherein the boss is supported on a base portion having a diameter larger than the outer diameter of the lower cylindrical portion.

14. The device of claim 13 wherein the circuit board has a top surface that contacts the lower cylindrical portion around the aperture of the circuit board and the circuit board has a bottom surface that contacts a ledge of the base portion around the aperture of the circuit board.

15. The device of claim 14 wherein the circuit board has an electrical connecter mounted on the top surface, the electrical connector protrudes through an opening in a bottom wall of the receiving bay, whereby the hard drive is electrically connected to the electrical connecter when the drawer is in a closed position.
